(19) United States
(12) Patent Application Publication
(10) Pub. No.: US 2025/0276499 A1
(43) Pub. Date: Sep. 4, 2025

(54) CO-MOLDED, METAL LINED, RESIN-IMPREGNATED FIBER-REINFORCED PARTS, AND METHODS OF MANUFACTURE

(71) Applicant: GM GLOBAL TECHNOLOGY OPERATIONS LLC, Detroit, MI (US)

(72) Inventors: Mary GILLIAM, Farmington Hills, MI (US); Venkateshwar R. AITHARAJU, Troy, MI (US)

(21) Appl. No.: 18/591,621

(22) Filed: Feb. 29, 2024

(51) Int. Cl. B29C 70/78; B29C 70/68; B29K 705/02

(52) U.S. Cl. CPC B29C 70/78; B29C 70/683; B29K 2705/02

(57) ABSTRACT

A co-molded metal lined, resin-impregnated fiber-reinforced part comprises a fiber preform; a metal layer overlying at least a portion of the fiber preform, having a modified surface adherent to thermoset resin; and a thermoset resin surrounding and impregnating the fiber preform and engaging the surface of the metal layer. A method of manufacturing a co-molded thermoset polymer composite with a metallic foil comprises depositing a thin film with a thickness less than 500 nm on the surface of the metal to be bonded with the composite, which includes hybrid organic and metal oxide groups; loading a fiber preform and the metal foil into a cavity of a mold; and injecting a thermoset resin into the mold to surround and impregnate the fiber preform and adhere to the thin film on the foil to form the co-molded composite.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

This disclosure relates to composite parts, and in particular to co-molded, metal lined, resin-impregnated fiber-reinforced parts.

A composite material is a material which combines two or more constituent materials to provide improved properties such as reduced expense, decreased weight, lighter, increased strength and/or increased durability. Reinforced polymers are an example of a class of composites that has found wide application, including in general automotive applications. However, for some applications, for example battery enclosures, where EMI shielding and/or enhanced thermal protection may be desirable, conventional reinforced polymer composites can be lacking.

### SUMMARY

Further areas of applicability of the present disclosure will become apparent from the detailed description, the claims and the drawings. The detailed description and specific examples are intended for purposes of illustration only and are not intended to limit the scope of the disclosure.

A first embodiment of the present disclosure provides co-molded metal lined, resin-impregnated fiber-reinforced parts. These parts can comprise a fiber preform and a metal layer overlying at least a portion of the fiber preform. The metal layer has a modified surface that is adherent to thermoset resin. A thermoset resin surrounds and impregnates the fiber preform and engages the modified surface of the metal layer.

The metal layer can be aluminum or an aluminum alloy. The metal layer can have a surface layer with a thickness greater than 10 nm consisting of metal oxide and metal oxide hydrate, in which the hydrate portion comprises between about 20% and about 50% of the layer on an atomic percentage basis. Where the metal layer is aluminum, this surface layer can comprise aluminum oxide and aluminum oxide hydrate.

The modified surface can be a thin film less than 500 nm that consists of a hybrid inorganic metal oxide and organic functional groups selected from one or more from the classes of epoxy, amine, acrylate, carboxylate, hydride, vinyl, sulfur-containing, phosphorus-containing, halogen-containing.

This thin film can be formed from one or more chemical precursors applied with an atmospheric pressure plasma. The one or more chemical precursors can include a molecule with hybrid organic and metal oxide groups, such as one or more of organic oxysilane compounds, such as silanol, Si-OH, with siloxane functional groups capable of forming a bond with a metal oxide surface and organic functional groups capable of forming a bond with the thermoset resin. In particular, the organic oxysilane compound can consist of at least one organic functional group selected from epoxy, amine, acrylate, carboxylate, hydride, vinyl, sulfur-containing, phosphorus-containing, halogen-containing.

The thermoset resin can be an epoxy, polyester, phenolic, or polyurethane. In one embodiment, the resin is an epoxy, and the chemical precursors to the thin film include an aminosilane and/or epoxysilane.

A second embodiment of the present disclosure provides a method of manufacturing a co-molded thermoset polymer composite with a metallic foil. This method of this embodiment can comprise depositing a thin film with a thickness less than 500 nm on the surface of the metal to be bonded with the composite, which includes hybrid organic and metal oxide groups. A fiber preform and the metal foil are loaded into a cavity of a mold; and a thermoset resin is injected into the mold cavity to surround and impregnate the fiber preform and adhere to the thin film on the foil to form the co-molded composite.’

The thin film can be deposited on the foil from one or more chemical precursors applied with an atmospheric pressure plasma. These chemical precursors comprise at least one organic alkoxysilane, such as a methoxysilane or an ethoxysilane, or a hydrolyzed organic alkoxysilane with one or more silanol groups, Si-OH, capable of forming a bond with the metal oxide surface and one or more organic functional groups bonded to the silane that is capable of forming a bond with the thermoset resin.

Prior to the step of depositing the thin film, the surface of the metal foil can be melted, for example with a pulsed infrared laser, to create a surface layer with a thickness greater than 10 nm comprising metal oxide and metal oxide hydrate, in which the hydrate portion is between about 20% and about 50% of the surface on an atomic percentage basis.

### BRIEF DESCRIPTION OF THE DRAWINGS

The present disclosure will become more fully understood from the detailed description and the accompanying drawings, wherein:

FIG. 1 is a cross-sectional view of a co-molded metal-lined, resin-impregnated fiber-reinforced part according to an embodiment of this disclosure;

FIG. 2 is a schematic diagram showing the application of a thin film to a metal foil in accordance with some of the embodiments of this disclosure;

FIG. 3 is a schematic diagram showing the treatment of the surface of metal foil in accordance with some of the embodiments of this disclosure;

FIG. 4 is a schematic diagram showing the co-molding of a metal lined, resin-impregnated fiber-reinforced part in accordance with some of the embodiments of this disclosure;

FIG. 5 is a graph Infrared absorbance spectra of an aluminum surface as-received (A) and one that was laser ablated (B).

FIG. 6 are graphs comparing untreated aluminum (left side) versus laser ablated aluminum (right side) using a pulsed laser with a 1030 nm wavelength operated at a 20 kHz pulse rate and 2 kW power giving a fluence of 9 J/cm²;

FIG. 7 are photographs showing the aluminum side (left) and the composite side (right) of a co-molded metal lined, resin-impregnated fiber-reinforced part, made with untreated aluminum;

FIG. 8 are photographs showing the aluminum side (left) and the composite side (right) of a co-molded metal lined, resin-impregnated fiber-reinforced part, made with aluminum treated with plasma deposition of GLYMO according to embodiments of this disclosure; and

FIG. 9 are photographs showing the aluminum side (left) and the composite side (right) of a co-molded metal lined, resin-impregnated fiber-reinforced part, made with aluminum treated with laser ablation according to embodiments of this disclosure.

In the drawings, reference numbers may be reused to identify similar and/or identical elements.

### DETAILED DESCRIPTION

A first embodiment of the present disclosure provides co-molded metal-lined, resin-impregnated fiber-reinforced parts. Such parts are useful in a variety of automotive applications, including for example battery enclosures for electric vehicles. The metal lining can provide EMI shielding and/or improved heat transfer and thermal regulation.

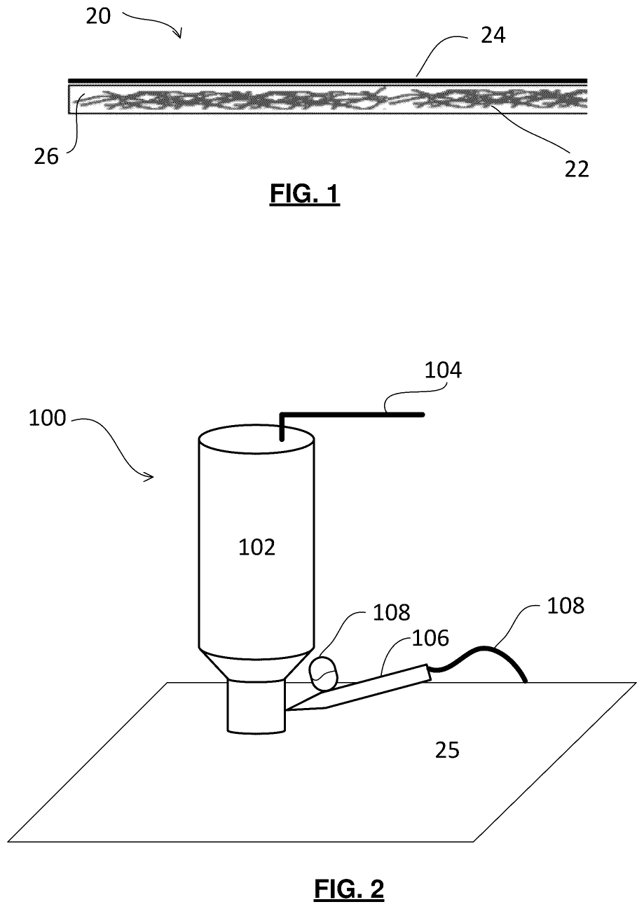

One such part is indicated as 20 in FIG. 1, and comprises a fiber preform 22 and a metal layer 24 overlying at least a portion of the fiber preform. The metal layer 24 has a modified surface that is adherent to thermoset resin. A thermoset resin 244 surrounds and impregnates the fiber preform 22 and engages and adheres to the modified surface of the metal layer 24.

The metal layer 24 can be an aluminum or an aluminum alloy foil. Alternatively, the metal layer could be some other metal, for example a steel or stainless steel foil. For many applications a thickness less than about 0.2 mm is sufficient, but in automotive applications for weight considerations, the thickness of a steel or stainless steel layer can be less than 0.1 mm. In some embodiments the metal layer 24 can have a surface layer with a thickness greater than 10 nm consisting of metal oxide and metal oxide hydrate, in which the hydrate portion comprises between about 20% and about 50% of the layer on an atomic percentage basis. This layer can be created by laser ablation. Where the metal layer is aluminum, this surface layer can comprise aluminum oxide and aluminum oxide hydrate.

The modified surface on the metal layer can be a thin film less than about 500 nm that consists of a hybrid inorganic metal oxide, such as an alkoxysilane, and organic functional groups selected from one or more from the classes of epoxy, amine, acrylate, carboxylate, hydride, vinyl, sulfur-containing, phosphorus-containing, halogen-containing, appropriate for the resin used.

This thin film can be formed from one or more chemical precursors applied to the surface of the metal layer 24 prior to exposure of the surface to atmospheric plasma and/or after exposure of the surface to atmospheric plasma or injected into the plasma jet prior to application onto the surface to create a thin film. The one or more chemical precursors can include a molecule with hybrid organic and metal oxide groups, such as one or more alkoxysilanes such as silanol, Si-OH, with siloxane functional groups capable of forming a bond with a metal oxide surface and organic functional groups capable of forming a bond with the thermoset resin 26. In particular, the organic oxysilane compound can consist of at least one organic functional group selected from epoxy, amine, acrylate, carboxylate, hydride, vinyl, sulfur-containing, phosphorus-containing, halogen-containing appropriate for the resin used.

The thermoset resin 26 can be an epoxy, polyester, phenolic, or polyurethane. In one embodiment, the resin is an epoxy, and the chemical precursors to the thin film include an aminosilane and/or epoxysilane.

A second embodiment of the present disclosure provides a method of manufacturing a co-molded thermoset polymer composite with a metallic layer. The method of this embodiment can comprise depositing a thin film with a thickness less than 500 nm on the surface of the metal layer 24 to be bonded with the composite. The thin film can include hybrid organic and metal oxide groups. The metal layer 24 can be any suitable metal or metal foil layer. In some embodiments the metal layer 24 is an aluminum or aluminum alloy foil.

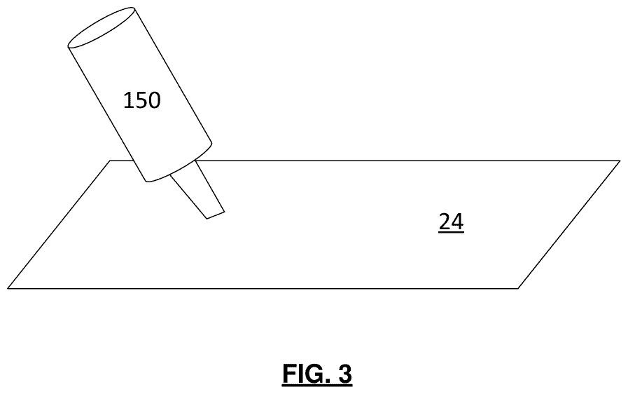

As shown in FIG. 2 the thin film can be deposited on the metal layer from one or more chemical precursors applied with an atmospheric pressure plasma system 100. The system comprises a plasma generator 102, with a gas supply 104 for supplying a gas such as nitrogen, argon, or air. An aerosol generator 106 with a reservoir 108 of chemical precursor and connected to a source 110 of nitrogen carrier gas injects the precursor a port downstream of the exit of the plasma generator 102 and into the plasma stream for application to the metal layer 26.

The one or more chemical precursors can include a molecule with hybrid organic and metal oxide groups, such as one or more alkoxysilanes such as silanol, Si-OH, with siloxane functional groups capable of forming a bond with a metal oxide surface and organic functional groups capable of forming a bond with the thermoset resin 26. In particular, the organic oxysilane compound can consist of at least one organic functional group selected from epoxy, amine, acrylate, carboxylate, hydride, vinyl, sulfur-containing, phosphorus-containing, halogen-containing appropriate for the resin used. In one embodiment the precursor chemicals include 3-glycidoxypropyl trimethoxysilane (GLYMO), an epoxysilane with an epoxide group as an organic functional group.

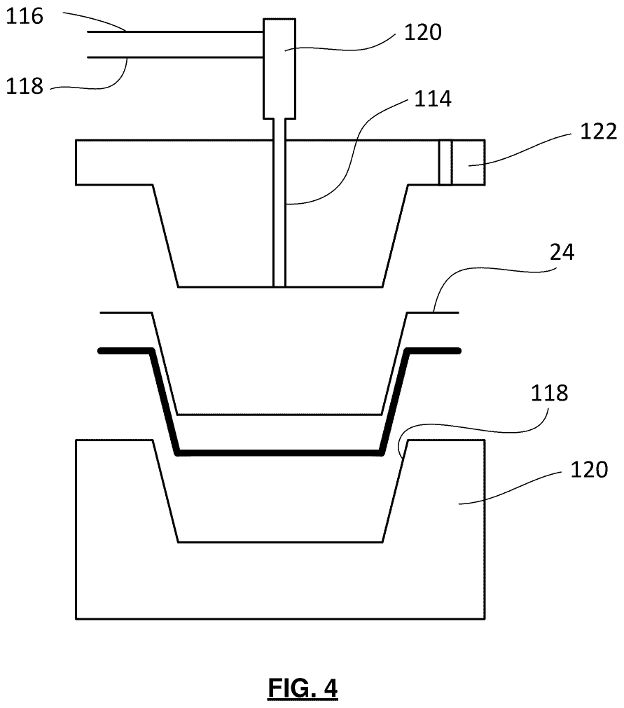

As shown in FIG. 4, a fiber preform 22 and the metal layer 24 are loaded into a cavity 118 of a mold 120. The metal layer 24 can be temporarily secured to the fiber preform 22. The mold 120 is closed with a lid 122, A thermoset resin 26 is injected into the mold cavity through an injection passage 114 in the lid 112. The resin 26 is preferably a two-part resin provided by separate supply lines 116 and 118 to a mixer 120 that communicates with the injection passage 114. The resin 26 surrounds and impregnates the fiber preform 22 and adhere to the thin film on the metal layer 24 to form the co-molded composite. The mold 110 can be heated to facilitate curing of the resin 26.

Suitable resins include an epoxy, polyester, phenolic, or polyurethane.

Prior to, or optionally instead of—in the case of some metal substrates (such as aluminum used with an epoxy-based thermosets), the step of depositing the thin film on the metal layer 24, the surface of the metal foil can be treated to create a surface layer of metal oxide and metal oxide hydrate. One way of accomplishing this is by melting the surface, for example with a pulsed infrared laser, to create a surface layer with a thickness greater than 10 nm comprising metal oxide and metal oxide hydrate, in which the hydrate portion is between about 20% and about 50% of the surface on an atomic percentage basis. As shown in FIG. 3, this can be accomplished by passing a laser 150 over the surface of the metal layer 26. The laser source can be a pulsed laser with a 1030 nm wavelength operated at a 20 kHz pulse rate and 2 kW power giving a fluence of 9 J/cm². Of course, other laser sources capable of reaching the fluence (J/cm²) that achieves the desired surface condition can be used. This includes laser sources with a Gaussian or tophat energy profile, having various spot sizes (such as ranging from about 50 microns to 1 mm), pulse frequency (such as ranging from about 5-200 kHz), and power (such as ranging from about 50W to 3 kW) that achieve the desired surface condition may be used. In general, the fluence should likely range from about 4 J/cm² to about 30 J/cm².

| | Binding | | Laser |
|---|---|---|---|
| Composition | Energy (eV) | Untreated | Ablated |
| Al | 73.08 | 0.124 | |
| Al₂O₃ | 74.15 | | 0.600 |
| Al(OH)₃ | 74.98 | 0.876 | |
| Al₂O₃ 3H₂O | 77.78 | | 0.400 |

The Table above shows X-Ray Photoelectron Spectroscopy (XPS) data for the untreated and laser ablated surfaces of an aluminum sheet. The binding energy of each form of aluminum is shown and the values are the atomic fractions of each aluminum form. . . . for example, the laser ablated surface shows 60 atomic % of aluminum oxide and 40 atomic % of aluminum oxide hydrate.

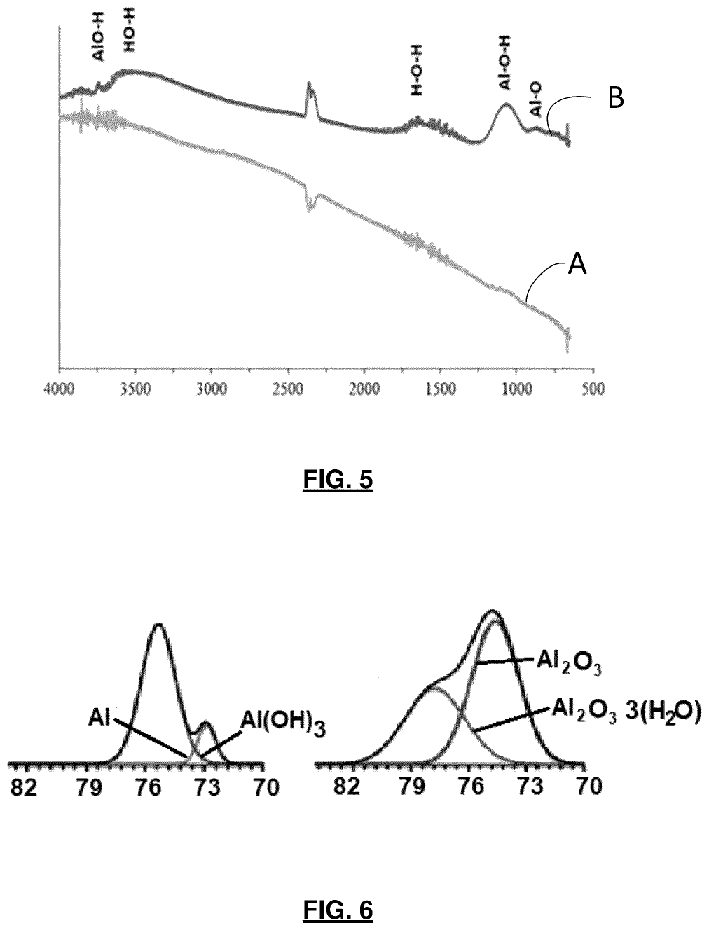

FIG. 5 is a graph showing infrared absorbance spectra of an aluminum surface as-received (A) and one that was laser ablated (B). The laser ablated surface shows bands associated with functional groups of an aluminum oxide/aluminum oxide hydrate surface, which is consistent with the XPS data in the table above.

FIG. 6 are graphs comparing untreated aluminum (left side) versus laser ablated aluminum (right side) using a pulsed laser with a 1030 nm wavelength operated at a 20 kHz pulse rate and 2 kW power giving a fluence of 9 J/cm²;

FIG. 7 are photographs showing the aluminum side (left) and the composite side (right) of a co-molded metal lined, resin-impregnated fiber-reinforced part, made with untreated aluminum, showing that the aluminum did not bond to the composite;

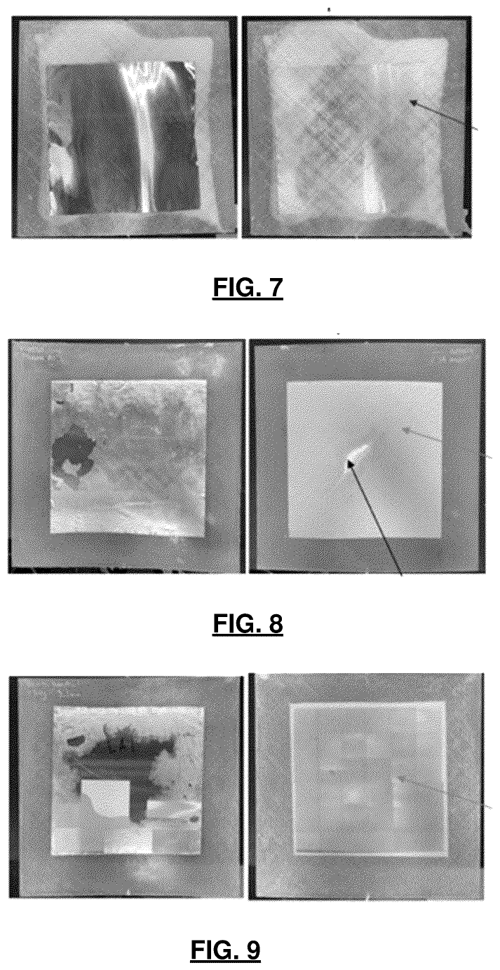

FIG. 8 are photographs showing the aluminum side (left) and the composite side (right) of a co-molded metal lined, resin-impregnated fiber-reinforced part, made with aluminum treated with plasma deposition of GLYMO according to embodiments of this disclosure, showing the aluminum bonded to the thermoset resin; and

FIG. 9 are photographs showing the aluminum side (left) and the composite side (right) of a co-molded metal lined, resin-impregnated fiber-reinforced part, made with aluminum treated with laser ablation according to embodiments of this disclosure, showing aluminum bonded to the thermoset resin.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

What is claimed is:

1. A co-molded metal lined, resin-impregnated fiber-reinforced part comprising:
a fiber preform;
a metal layer overlying at least a portion of the fiber preform, having a modified surface adherent to thermoset resin; and
a thermoset resin surrounding and impregnating the fiber preform and engaging a surface of the metal layer.

2. The co-molded metal lined, resin-impregnated fiber-reinforced part according to claim 1 wherein the metal layer is aluminum or an aluminum alloy.

3. The co-molded metal lined, resin-impregnated fiber-fiber-reinforced part according to claim 2 wherein the thermoset resin is an epoxy, polyester, phenolic, or polyurethane.

4. The co-molded metal lined, resin-impregnated fiber-fiber-reinforced part according to claim 1 wherein the thermoset resin is an epoxy, polyester, phenolic, or polyurethane.

5. The co-molded metal lined, resin-impregnated fiber-fiber-reinforced part according to claim 4, where the modified surface of the metal layers comprises a thin film less than 500 nm that consists of a hybrid inorganic metal oxide and organic functional groups selected from one or more from the classes of epoxy, amine, acrylate, carboxylate, hydride, vinyl, sulfur-containing, phosphorus-containing, halogen-containing.

6. The co-molded metal lined, resin-impregnated fiber-fiber-reinforced part according to claim 1, where the modified surface of the metal layer comprises a thin film less than 500 nm that consists of a hybrid inorganic metal oxide and organic functional groups selected from one or more from the classes of epoxy, amine, acrylate, carboxylate, hydride, vinyl, sulfur-containing, phosphorus-containing, halogen-containing.

7. The co-molded metal lined, resin-impregnated fiber-fiber-reinforced part according to claim 6, wherein the thin film is formed from one or more chemical precursors applied with an atmospheric pressure plasma.

8. The co-molded metal lined, resin-impregnated fiber-fiber-reinforced part according to claim 7, wherein the one or more chemical precursors include alkoxysilanes a molecule with hybrid organic and metal oxide groups, with at least one organic functional group that bonds with the thermoset resin.

9. The co-molded metal lined, resin-impregnated fiber-fiber-reinforced part according to claim 8, wherein the one or more chemical precursors include one or more of organic oxysilane compounds with siloxane functional groups capable of forming a bond with a metal oxide surface and organic functional groups capable of forming a bond with the thermoset resin.

10. The co-molded metal lined, resin-impregnated fiber-fiber-reinforced part according to claim 9, wherein the organic oxysilane compound comprises a hydrolyzed alkoxysilane with at least one silanol group (Si—)OH.

11. The co-molded metal lined, resin-impregnated fiber-fiber-reinforced part according to claim 9, wherein the organic oxysilane compound consists of at least one organic functional group selected from epoxy, amine, acrylate, carboxylate, hydride, vinyl, sulfur-containing, phosphorus-containing, halogen-containing.

12. The co-molded metal lined, resin-impregnated fiber-fiber-reinforced part according to claim 8, wherein the one or more chemical precursors include an aminosilane and/or epoxysilane, and the thermoset resin is an epoxy.

13. The co-molded metal lined, resin-impregnated fiber-fiber-reinforced part according to claim 8, wherein the metal layer has a surface layer with a thickness greater than 10 nm consisting of metal oxide and metal oxide hydrate, in which the hydrate portion comprises between about 20% and about 50% of the layer on an atomic percentage basis.

14. The co-molded metal lined, resin-impregnated fiber-fiber-reinforced part according to claim 13, wherein the metal layer is aluminum and the surface consists of aluminum oxide and aluminum oxide hydrate.

15. A method of manufacturing a co-molded thermoset polymer composite with a metallic foil comprising the steps of:
depositing a thin film with a thickness less than 500 nm on the surface of the metal to be bonded with the composite, which includes hybrid organic and metal oxide groups;
loading a fiber preform and the metal foil into a cavity of a mold;
injecting a thermoset resin into the mold to surround and impregnate the fiber preform and adhere to the thin film on the foil to form the co-molded composite.

16. The method of manufacturing a co-molded thermoset polymer composite with a metallic foil according to claim 15, wherein the thin film is deposited on the foil from one or more chemical precursors applied with an atmospheric pressure plasma.

17. The method of manufacturing a co-molded thermoset polymer composite with a metallic foil according to claim 16, wherein the one or more chemical precursors comprise at least one organic oxysilane compound with siloxane functional groups capable of forming a bond with the metal oxide surface and organic functional groups capable of forming a bond with the thermoset resin.

18. The method of manufacturing a co-molded thermoset polymer composite with a metallic foil according to claim 17, wherein at least one of the at least one organic oxysilane compounds consists of at least one group as a silanol, Si-OH.

19. The method of manufacturing a co-molded thermoset polymer composite with a metallic foil according to claim 15, wherein prior to the step of depositing the thin film, the surface of the metal foil is melted and resolidified under conditions that create a surface layer with a thickness greater than 10 nm comprising metal oxide and metal oxide hydrate, in which the hydrate portion is between about 20% and about 50% of the surface on an atomic percentage basis.

20. The method of manufacturing a co-molded thermoset polymer composite with a metallic foil according to claim 17 wherein the surface of the metal foil is melted by the application of a pulsed infrared laser.
